(19) United States
(12) Patent Application Publication
(10) Pub. No.: US 2012/0166166 A1
(43) Pub. Date: Jun. 28, 2012

(54) System and Method Visualizing Data Corresponding to Physical Objects

(76) Inventor: Marek K. Czernuszenko, Sugar Land, TX (US)

(21) Appl. No.: 13/388,203

(22) PCT Filed: Jul. 1, 2010
(86) PCT No.: PCT/US10/40763

§ 371 Date: Jan. 31, 2012

Related U.S. Application Data
(60) Provisional application No. 61/242,162, filed on Sep. 14, 2009.

(51) Int. Cl. G06G 7/48

(52) U.S. Cl. 703/6

(57) ABSTRACT

There is provided an exemplary method for providing a visualization of data describing a physical structure, the visualization being provided with respect to a grid that represents data. The exemplary method comprises selecting a cross-section that intersects the grid, the cross-section corresponding to a region of interest. The exemplary method also comprises limiting at least one of a width or a height of the cross-section to create a viewing section. The exemplary method additionally comprises displaying data on a portion of the grid corresponding to the viewing section.

### CROSS-REFERENCE TO RELATED APPLICATION

This application claims the benefit of U.S. Provisional Patent Application 61/242,162, filed Sep. 14, 2009, entitled SYSTEM AND METHOD VISUALIZING DATA CORRESPONDING TO PHYSICAL OBJECTS, the entirety of which is incorporated by reference herein.

### FIELD

The present techniques relate to providing three-dimensional (3D) visualizations of data corresponding to physical objects. In particular, an exemplary embodiment of the present techniques relates to providing 3D volume visualizations of a subsurface region, including visualizations of a structured grid (for example, seismic and seismic derived volumes), a semi-structured grid-like geologic model or simulation model, and/or a fully unstructured grid.

### BACKGROUND

This section is intended to introduce various aspects of the art, which may be associated with embodiments of the disclosed techniques. This discussion is believed to assist in providing a framework to facilitate a better understanding of particular aspects of the disclosed techniques. Accordingly, it should be understood that this section is to be read in this light, and not necessarily as admissions of prior art.

Three-dimensional (3D) model construction and visualization have been widely accepted by numerous disciplines as a mechanism for analyzing, communicating, and comprehending complex 3D datasets. Examples of structures that can be subjected to 3D analysis include the earth's subsurface, facility designs and the human body, to name just three examples.

The ability to easily interrogate and explore 3D models is one aspect of 3D visualization. Relevant models may contain both 3D volumetric and co-located 3D polygonal objects. Examples of volumetric objects are seismic volumes, MRI scans, reservoir simulation models, and geologic models. Interpreted horizons, faults and well trajectories are examples of polygonal objects. If every cell of the 3D volumetric object is rendered fully opaque, other objects in the scene will of necessity be occluded. There is a need to view the volumetric and polygonal objects concurrently to understand their geometric and property relations. These tasks are important during exploration, development and production phases in the oil and gas industry. Similar needs exist in other industries.

3D volumetric objects may be divided into two basic categories: structured grids and unstructured grids. Both structured and unstructured grids may be rendered for a user to explore and understand the associated data. There are large numbers of known volume rendering techniques. Many known techniques render a full 3D volume with some degree of transparency, which enables the user to “see through” the data.

Another approach to rendering 3D object properties is the use of iso-surfaces, which represent data points having the same or similar values. The use of iso-surfaces, however, does not produce useful visualizations of seismic data or data derived therefrom because of the rapid change of seismic parameter values along the depth direction. Accordingly, the use of iso surfaces for visualizing data is not common in the oil and gas industry.

A known way to view and interrogate a 3D volume is to render a cross-section through the 3D volume. The surface of the intersection between the cross-section and the 3-D volume may be rendered as a polygon with texture-mapped volume cell properties added thereto. In the case of a structured grid such as seismic or a medical scan, the user can create cross-sections along one of the primary directions: xy (inline or axial), xz (cross line or coronal) and yz (time slice or sagital). A traditional cross-section spans the extent of the object. In this case other objects such as horizons, wells or the like are partially or completely occluded and it is difficult to discern 3D relationships between objects.

This effect is shown in FIG. 1, which is a graph 100 of a subsurface region showing a cross-sectional 3D view of a subsurface region with two horizons partially occluded. The graph is generally referred to by reference number 100. The graph 100, which may provide a visualization of 3D data for a structured grid or an unstructured grid, comprises an xline axis 102, an inline axis 104 and a time or depth axis 106. A cross-section 108 shows data values for a 3D data volume. Two horizons 110 and 112 are co-located with the grid. As shown in FIG. 1, the cross-section 108 mostly occludes the first horizon 110 and the second horizon 112, so that most of the horizon data cannot be viewed while the cross-sectional plane 108 is displayed.

Another example of horizon occlusion is shown in FIG. 2, which is a 3D graph 200 of a subsurface region. The graph 200, which may provide a visualization of 3D data for a structured grid or an unstructured grid, shows a first cross-section 202, a second cross-section 204, a third cross-section 206 and a fourth cross-section 208. Each of the four cross-sections shown in FIG. 2 is chosen to allow a user to see data of interest in a 3D data volume. However, a first horizon 210 and a second horizon 212, as well as data displayed on cross-sections 202, 204 and 206 which also may be of interest to a user, are mostly obscured or occluded by the visualizations of the four cross-sections.

The ribbon section, also called an arbitrary vertical cross section, is one attempt to make traditional cross-sections more flexible. To create a ribbon section, the user digitizes a polyline on one face of a volume bounding box. The poly line is extended through the volume creating a curtain or ribbon, and the volumetric data is painted on the curtain surface.

U.S. Pat. Nos. 7,098,908 and 7,248,258 disclose a system and method for analyzing and imaging 3D volume data sets using ribbon sections. In one disclosed system, a ribbon section is produced which may include a plurality of planes projected from a polyline. The polyline includes one or more line segments preferably formed within a plane. The projected planes intersect the 3D volume data set and the data located at the intersection may be selectively viewed. The polyline may be edited or varied by editing or varying the control points which define the polyline. Physical phenomena represented within the three-dimensional volume data set may be tracked. A plurality of planes may be successively displayed in the three-dimensional volume data set from which points are digitized related to the structure of interest to create a spline curve on each plane. The area between the spline curves is interpolated to produce a surface representative of the structure of interest, which may for example be a fault plane described by the three-dimensional volume data set. This may allow a user to visualize and interpret the features and physical parameters that are inherent in the three-dimensional volume data set.

This concept of arbitrary vertical cross-sections (i.e., ribbon sections) is depicted in FIG. 3, which is a 3D graph 300 of a subsurface region showing arbitrary vertical cross-sections. The graph 300, which may provide a visualization of 3D data for a structured grid or an unstructured grid, shows a first arbitrary cross-section 302 and a second arbitrary cross-section 304. Although the arbitrary cross-sections shown in FIG. 3 are less intrusive than the cross-sections shown in FIGS. 1 and 2, portions of a first horizon 306 and a second horizon 308 are still occluded as long as the first arbitrary cross-section 302 and the second arbitrary cross-section 304 are displayed.

Another known attempt to avoid occlusion in 3D imaging is for a user to select one or more variable subsets of the 3D data. These subsets may be used to display a sub-volume of a regular grid, and can be repositioned and resized. The subsets may be created, shaped, and moved interactively by the user within the whole 3D volume data set. As a subset changes shape, size, or location in response to user input, the image is re-drawn at a rate so as to be perceived as real-time by the user. In this manner, the user is allegedly able to visualize and interpret the features and physical parameters that are inherent in the 3D volume data set. However, manipulating data subsets can be difficult because the user can move and scale the subsets in six directions (up, down, left, right, forward and back).

FIG. 4 is a 3D graph 400 of a subsurface region showing an area of interest identified by a 3-D data subset. The graph 400, which may provide a visualization of 3D data for a structured grid or an unstructured grid, shows a 3D data subset 402. A first horizon 404 and a second horizon 406 are also shown. In the graph 400, the second horizon 406 is partially occluded by the 3D data subset 402.

### SUMMARY

An exemplary embodiment of the present techniques comprises a method for providing a visualization of data describing a physical structure. The visualization may be provided with respect to a 3D grid that represents data. The method comprises selecting a cross-section that intersects the grid, the cross-section corresponding to a region of interest. The method also comprises limiting at least one of a width or a height of the cross-section to create a viewing section. The method additionally comprises displaying data on a portion of the grid corresponding to the viewing section.

One exemplary method comprises displaying the grid data on the plane prior to limiting at least one of the width or the height of the cross-section. The viewing section may be selected such that the viewing section does not occlude an area of a display for which occlusion is to be avoided.

The method may comprise resizing at least one of the width or the height of the viewing section. In addition, the method may comprise repositioning the viewing window to a new position with respect to the grid. Data may be displayed on a portion of the grid corresponding to the new width and/or height and/or the new position of the viewing section.

A method according to the present techniques may comprise changing an orientation of the viewing section to a new orientation with respect to the grid. The method may additionally comprise displaying data on a portion of the grid corresponding to the new orientation of the viewing section.

Exemplary embodiments of the present techniques may relate to providing visualizations on a structured grid. Alternatively, visualizations may be provided on an unstructured grid.

One exemplary embodiment of the present technique comprises selecting a second cross-section of the grid that corresponds to a second region of interest without respect to whether data corresponding to the second section of the grid, if displayed, would occlude a portion of the grid for which occlusion is to be avoided. At least one of a width or a height of the second cross-section may be limited to create a second viewing section such that the second viewing section, when applied to the grid, does not occlude the portion of the grid for which occlusion is to be avoided. Additionally, data may be displayed on a portion of the grid corresponding to the second viewing section while the data displayed on the portion of the grid corresponding to the viewing section is still being displayed. The display of the data on the portion of the grid corresponding to the second viewing section does not occlude the at least the portion of the grid for which occlusion is to be avoided.

One exemplary embodiment of the present techniques relates to a computer system that is adapted to provide a visualization of data describing a physical structure. The visualization may be provided with respect to a grid that represents data. The computer system comprises a processor and a tangible, machine-readable storage medium that stores machine-readable instructions for execution by the processor. The machine-readable instructions comprise code that, when executed by the processor, is adapted to cause the processor to select a cross-section that intersects the grid, the cross-section corresponding to a region of interest. The machine-readable instructions also comprise code that, when executed by the processor, is adapted to cause the processor to limit at least one of a width or a height of the cross-section to create a viewing section. The machine-readable instructions additionally comprise code that, when executed by the processor, is adapted to cause the processor to display data on a portion of the grid corresponding to the viewing section.

An exemplary computer system may comprise code that, when executed by the processor, is adapted to cause the processor to display the grid data on the plane prior to limiting the width and/or the height of the cross-section. The computer system may comprise code that, when executed by the processor, is adapted to cause the processor to select the viewing section such that the viewing section does not occlude an area of a display for which occlusion is to be avoided.

The computer system may comprise code that, when executed by the processor, is adapted to cause the processor to resize at least one of the width or the height of the viewing section. In addition, the computer system may comprise code that, when executed by the processor, is adapted to cause the processor to reposition the viewing window to a new position with respect to the grid. The computer system may further comprise code that, when executed by the processor, is adapted to cause the processor to change an orientation of the viewing section to a new orientation with respect to the grid.

Computer systems according to exemplary embodiments of the present techniques may produce visualizations relative to a structured grid. In addition, computer systems according to exemplary embodiments of the present techniques may produce visualizations relative to an unstructured grid.

Another exemplary embodiment according to the present techniques relates to a method for producing hydrocarbons from an oil and/or gas field. The method comprises selecting a cross-section that intersects a grid that represents data. The cross-section corresponds to a region of interest. The method also comprises limiting at least one of a width or a height of the cross-section to create a viewing section and displaying data on a portion of the grid corresponding to the viewing section. The method additionally comprises extracting hydrocarbons from the oil and/or gas field using the displayed data.

### DESCRIPTION OF THE DRAWINGS

Advantages of the present techniques may become apparent upon reviewing the following detailed description and drawings of non-limiting examples of embodiments in which:

FIG. 1 is a graph of a subsurface region showing a cross-sectional 3D view of a subsurface region with two horizons partially occluded;

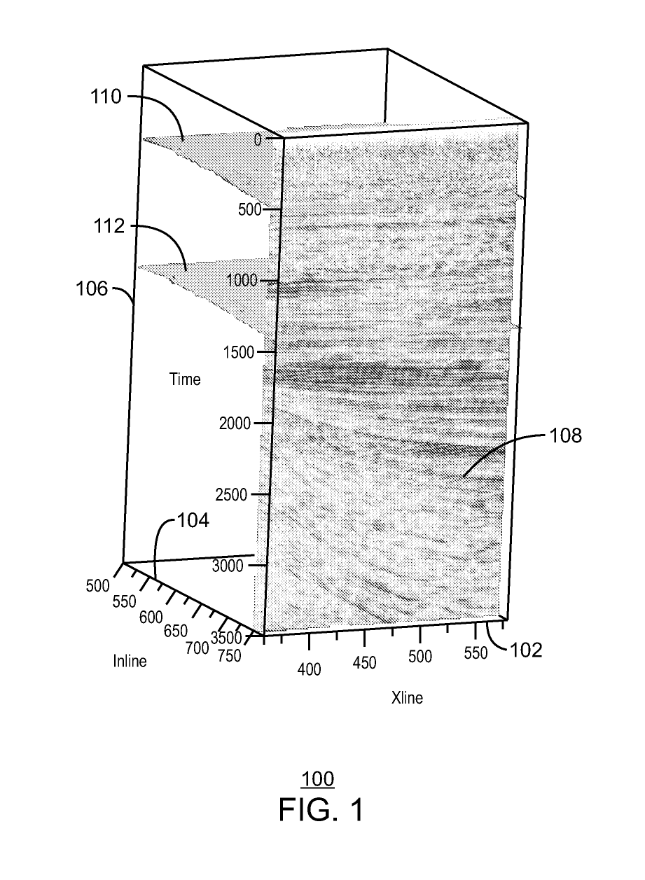

FIG. 2 is a 3D graph of a subsurface region showing a combination of four cross-sections with two horizons mostly occluded;

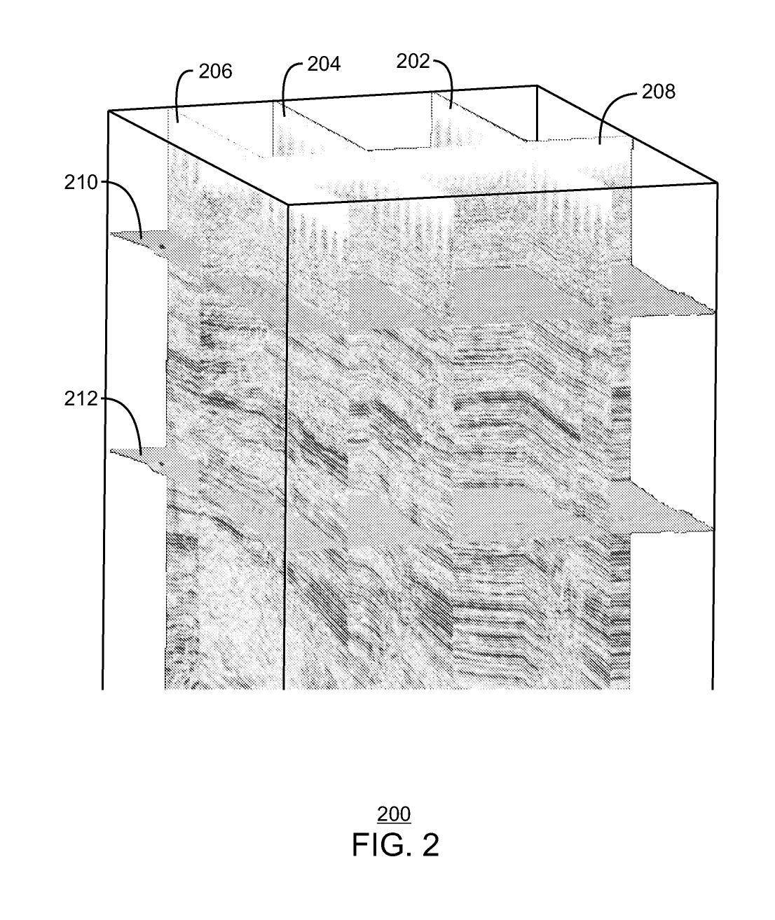

FIG. 3 is a 3D graph of a subsurface region showing arbitrary vertical cross-sections with two horizons partially occluded;

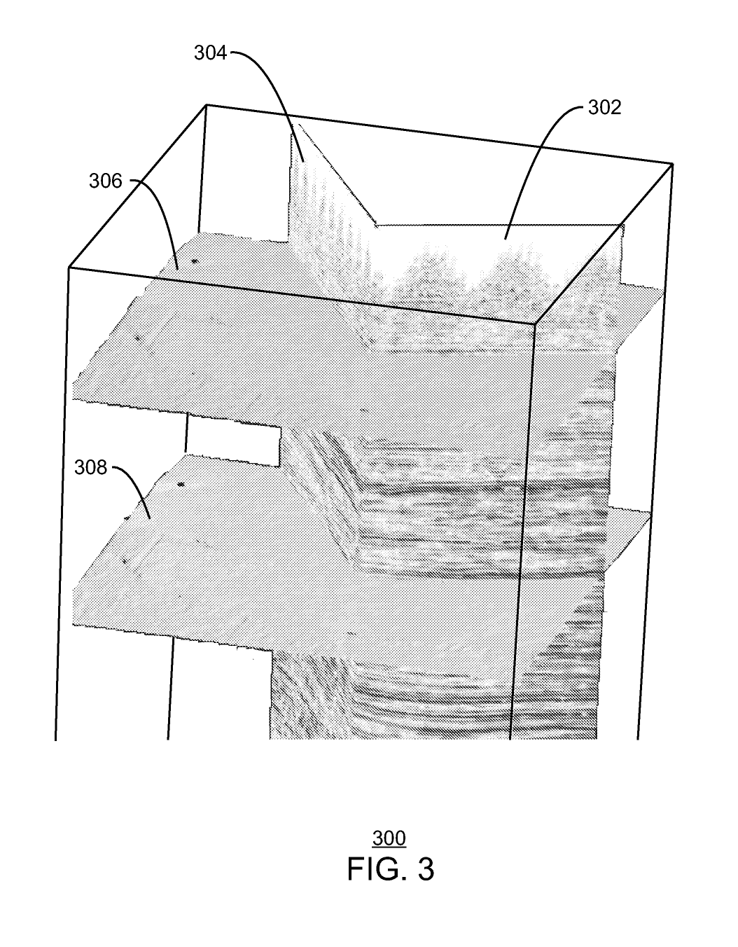

FIG. 4 is a 3D graph of a subsurface region showing a region of interest identified by a sub-volume probe with one horizon partially occluded;

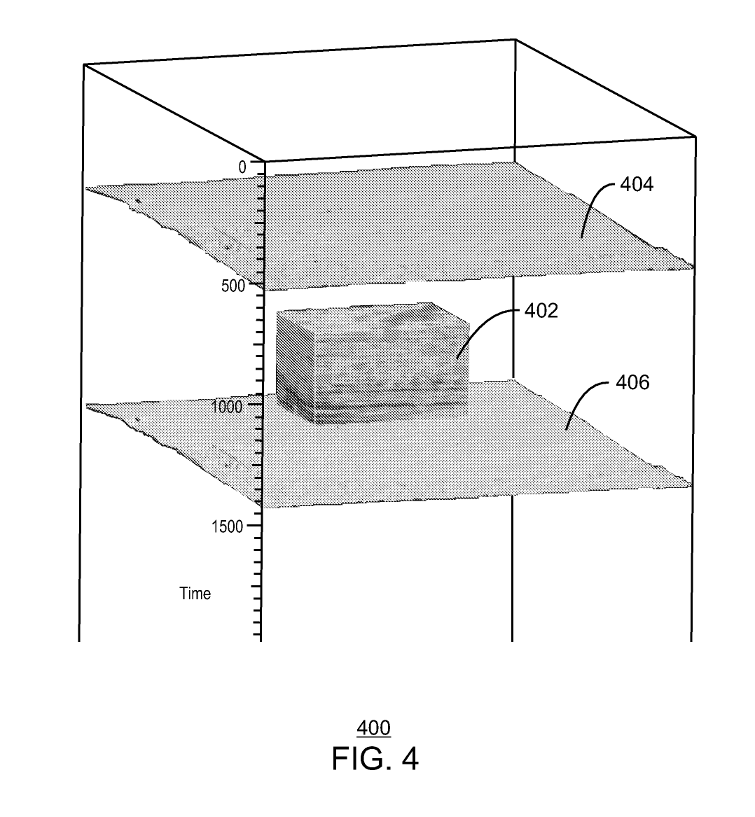

FIG. 5 is a 3D graph of a subsurface region showing a region of interest according to the present techniques with neither of two horizons occluded;

FIG. 6 is a process flow diagram showing a method for providing visualizations of data that represents a physical object according to exemplary embodiments of the present techniques;

FIG. 7 is a process flow diagram showing a method for producing hydrocarbons from a subsurface region such as an oil and/or gas field according to exemplary embodiments of the present techniques; and

FIG. 8 is a block diagram of a computer network that may be used to perform a method for providing visualizations of data that represents a physical object according to exemplary embodiments of the present techniques.

### DETAILED DESCRIPTION

In the following detailed description section, specific embodiments are described in connection with preferred embodiments. However, to the extent that the following description is specific to a particular embodiment or a particular use, this is intended to be for exemplary purposes only and simply provides a description of the exemplary embodiments. Accordingly, the present techniques are not limited to embodiments described herein, but rather, it includes all alternatives, modifications, and equivalents falling within the spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent.

As used herein, the term “3D data volume” refers to a collection of data that describes a 3D object. An example of a 3D data volume that describes a portion of a subsurface region is a 3D seismic data volume.

As used herein, the term “3D seismic data volume” refers to a 3D data volume of discrete x-y-z or x-y-t data points, where x and y are not necessarily mutually orthogonal horizontal directions, z is the vertical direction, and t is two-way vertical seismic signal travel time. In subsurface models, these discrete data points are often represented by a set of contiguous hexahedrons known as cells or voxels. Each data point, cell, or voxel in a 3D seismic data volume typically has an assigned value (“data sample”) of a specific seismic data attribute such as seismic amplitude, acoustic impedance, or any other seismic data attribute that can be defined on a point-by-point basis.

As used herein, the term “cell” refers to a closed volume formed by a collection of faces, or a collection of nodes that implicitly define faces.

As used herein, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and/or a computer. One or more computer components can reside within a process and/or thread of execution and a computer component can be localized on one computer and/or distributed between two or more computers.

As used herein, the terms “computer-readable medium” or “machine-readable medium” refer to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present techniques are considered to include a tangible storage medium or distribution medium and prior art-recognized equivalents and successor media, in which the software implementations of the present techniques are stored.

As used herein, the term “structured grid” refers to a matrix of volume data points known as voxels. Structured grids typically are used with seismic data volumes.

As used herein, the term “seismic data” refers to a multi-dimensional matrix or grid containing information about points in the subsurface structure of a field, where the information was obtained using seismic methods. Seismic data typically is represented using a structured grid. Seismic attributes or properties are cell- or voxel-based. Seismic data may be volume rendered with opacity or texture mapped on a surface.

As used herein, the term “voxel” refers to the smallest data point in a 3D volumetric object. Each voxel has unique set of coordinates and contains one or more data values that represent the properties at that location. Each voxel represents a discrete sampling of a 3D space, similar to the manner in which pixels represent sampling of the 2D space. The location of a voxel can be calculated by knowing the grid origin, unit vectors and the i, j, k indices of the voxel. As voxels are assumed to have similar geometries (such as cube-shaped), the details of the voxel geometries do not need to be stored, thus structured grids require relatively little memory. However, dense sampling may be needed to capture small features, therefore increasing computer memory usage requirements.

As used herein, the term “unstructured grid” refers to a collection of cells with arbitrary geometries. Each cell can have the shape of a prism, hexahedron, or other more complex 3D geometries. When compared to structured grids, unstructured grids can better represent actual data since unstructured grids can contain finer (i.e., smaller) cells in areas where there are rapid property changes, and coarser (i.e., larger) cells where properties do not change. This flexibility allows the unstructured grid to represent physical properties better than structured grids. However, all cell geometries need to be stored explicitly, thus an unstructured grid requires a substantial amount of memory. Unstructured grids typically are used with reservoir simulation models and/or geologic models.

As used herein, the term “face” refers to a collection of vertices.

As used herein, the term “simulation model” refers to a structured grid or an unstructured grid with collections of points, faces and cells.

As used herein, the term “geologic model” refers to a model that is topologically structured in I,J,K space but geometrically varied. A geologic model may be defined in terms of nodes and cells. Geologic models can also be defined via pillars (columnar cells or 2.5D grid (i.e., a 3D grid extruded from a 2D grid)). A geologic model may be visually rendered as a shell (i.e., a volume with data displayed only on outer surfaces).

As used herein, the term “cross-section” refers to a plane that intersects a structured grid or an unstructured grid. For a structured grid in the I,J,K space, an IJ cross-section displays all cells with the same K index. The grid which has Kmax samples in the K direction, will have Kmax different IJ cross-sections. Similarly the IK cross-section displays all cells with the same J index and the JK cross-sections displays all cells with the same I index.

As used herein, the term “horizon” refers to a geologic boundary in the subsurface structures that are deemed important by an interpreter. Marking these boundaries is done by interpreters when interpreting seismic volumes by drawing lines on a seismic section. Each line represents the presence of an interpreted surface at that location. An interpretation project typically generates several dozen and sometimes hundreds of horizons. Horizons may be rendered using different colors so that they stand out in a 3D visualization of data.

As used herein, the term “I,J,K space” refers to an internal coordinate system for a 3D grid, having specified integer coordinates for (i,j,k) for consecutive cells. By convention, K represents a vertical coordinate. I,J,K space may be used as a sample space in which each coordinate represents a single sample value without reference to a physical characteristic.

As used herein, the term “plane” refers to a surface which has infinite width and length, zero thickness, and zero curvature.

As used herein, the term “node” refers to a point defining a topological location in I,J,K space. If a split or fault condition is associated with the node, that node may have more than one point associated therewith.

As used herein, the term “stacking” is a process in which traces (i.e., seismic data recorded from a single channel of a seismic survey) are added together from different records to reduce noise and improve overall data quality. Characteristics of seismic data (e.g., time, frequency, depth) derived from stacked data are referred to as “post-stack” but are referred to as “pre-stack” if derived from unstacked data. More particularly, the seismic data set is referred to being in the pre-stack seismic domain if unstacked and in the post-stack seismic domain if stacked. The seismic data set can exist in both domains simultaneously in different copies.

Some portions of the detailed description which follows are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions using the terms such as “selecting”, “displaying”, “limiting”, “processing”, “computing”, “obtaining”, “predicting”, “providing”, “updating”, “comparing”, “determining”, “adjusting” or the like, refer to the action and processes of a computer system, or similar electronic computing device, that transforms data represented as physical (electronic) quantities within the computer system's registers and memories into other data similarly represented as physical quantities within the computer system memories or registers or other such information storage, transmission or display devices. Example methods may be better appreciated with reference to flow diagrams.

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various serially occurring actions, it is to be appreciated that various actions could occur concurrently, substantially in parallel, and/or at substantially different points in time.

Embodiments of the present techniques are described herein with respect to methods for conditioning process-based models to field and production data which include but are not limited to seismic data, well logs and cores, outcrop data, production flow information, or the like.

Exemplary embodiments of the present techniques relate to a visualization system that allows for the investigation, interrogation and visualization of volumetric objects using viewing sections. The user can create one or more viewing sections, and change their position and/or orientation. A viewing section can be manipulated in such a way that other 3D objects are not occluded, thus allowing easy comprehension and analysis of a 3D scene. Visualizations of mini-sections may be applied to both structured and fully unstructured grids.

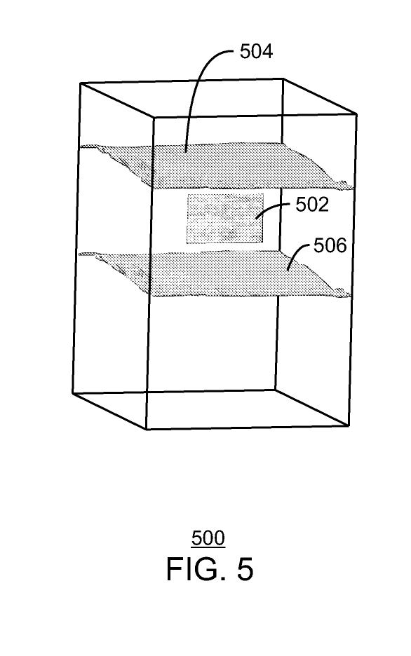

FIG. 5 is a 3D graph 500 of a subsurface region showing a region of interest according to the present techniques with neither of two horizons occluded. The graph 500, which may provide a visualization of 3D data for a structured grid or an unstructured grid, shows a viewing section 502 that does not occlude any of a first horizon 504 or a second horizon 506. The viewing section 502 shows data of interest to a user from a 3D data volume. Because the viewing section 502 is defined to be in an area that does not occlude the first horizon 504 or the second horizon 506, the user is able to observe the first horizon 504 and the second horizon 506 while the viewing section 502 is being displayed.

The viewing section 502 is readily movable by a user. In this manner, the user may see data from different regions of the 3D data volume without occluding the first horizon 504 or the second horizon 506. Thus, the user may see the first horizon 504 and the second horizon 506 while exploring other areas of the 3D data volume represented in the graph 500.

Where either a structured grid or an unstructured grid are being used, one or more horizons, faults, wells or other 3D objects are identified by virtue of their interest to the user. A cross-section is created along one of the primary grid directions identified by an x-axis, a y-axis or a z-axis, or in the case of an unstructured grid, the cross-section may be created by any suitable means. Even though the cross-section is created in a computer component such as a memory device, the entire cross-section is not necessarily displayed as part of a visualization of data; instead, the width and height of the cross-section may be limited so that it does not occlude the horizons of interest to the user. Moreover, the limiting of the height and width of the cross-section may be performed manually by a user or automatically before providing a display of a viewing section. By way of example, the user may specify in advance portions of a display area that are not to be occluded. Thereafter, displays of viewing sections are automatically limited to avoid the specified areas.

After the width and height of the cross-section is limited, data corresponding to the resulting viewing section 502 is displayed as part of the visualization of the 3D data volume. In this manner, the first horizon 504 and the second horizon 506 are not occluded by the viewing section 502. After it is displayed as part of the visualization of the 3D data volume, the viewing section 502 may be repositioned by user input. In addition, the orientation of the viewing section 502 may be changed by user input. After any changes in position or orientation of the viewing section 502, the visualization is updated immediately for viewing by the user. In this manner, the user may explore all areas of the visualization of the 3D data volume displayed using a structured grid, including areas such that the first horizon 504 and the second horizon 506 are not occluded.

Whether visualizations are being displayed via a structured grid or an unstructured grid, multiple viewing sections may be displayed at the same time. Moreover, the multiple viewing sections may coexist in a scene with other polygonal and/or volumetric objects.

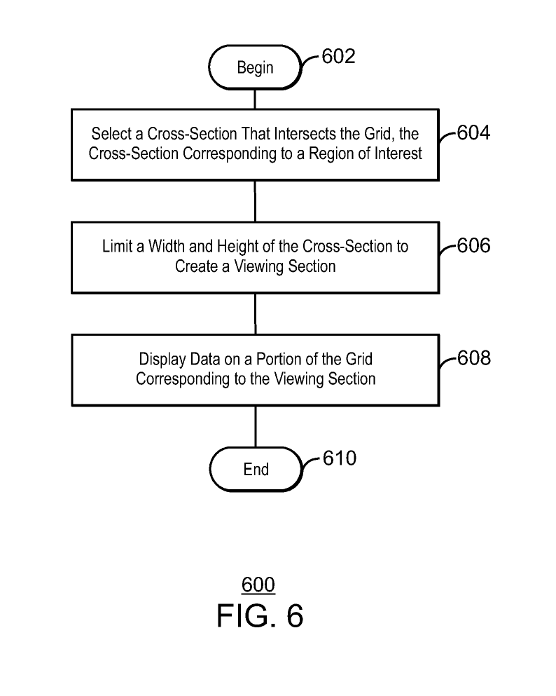

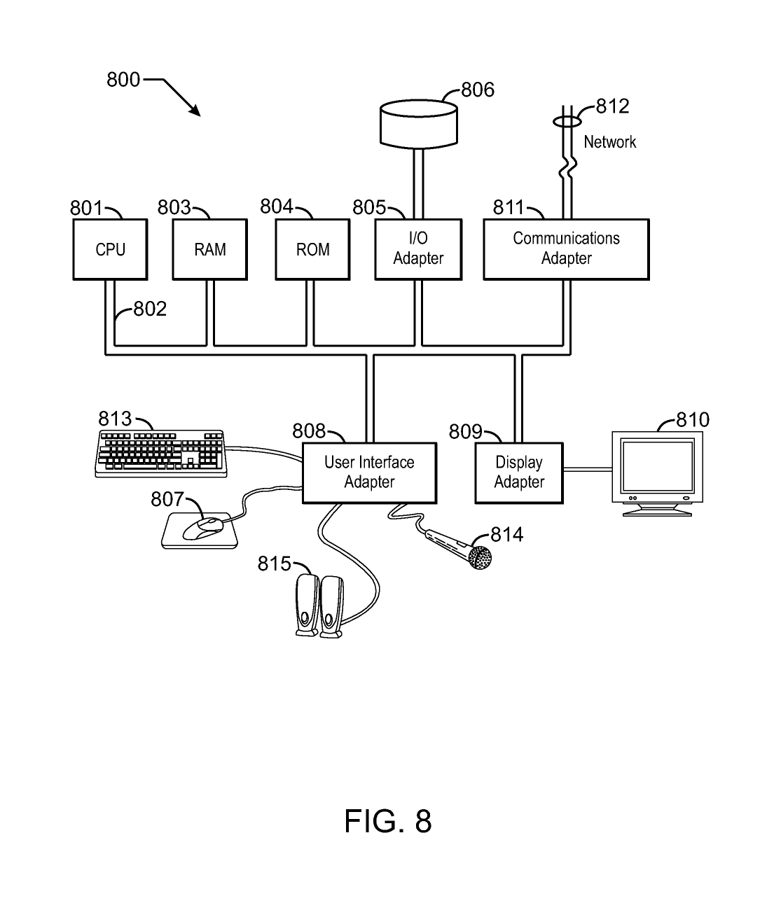

FIG. 6 is a process flow diagram showing a method for providing visualizations of data that represents a physical object according to exemplary embodiments of the present techniques. The process is generally referred to by the reference number 600. The process 600 may be executed using one or more computer components of the type described below with reference to FIG. 8. Such computer components may comprise one or more tangible, machine-readable medium that stores computer-executable instructions. The process 600 begins at block 602.

According to an exemplary embodiment of the present techniques, the visualization may be provided with respect to a grid that represents data. At block 604, a cross-section that intersects the grid is selected. The cross-section corresponds to a region of interest.

At block 606, a width and height of the cross-section are limited to create a viewing section. At block 608, data is displayed on a portion of the grid corresponding to the viewing section. The method ends at block 610.

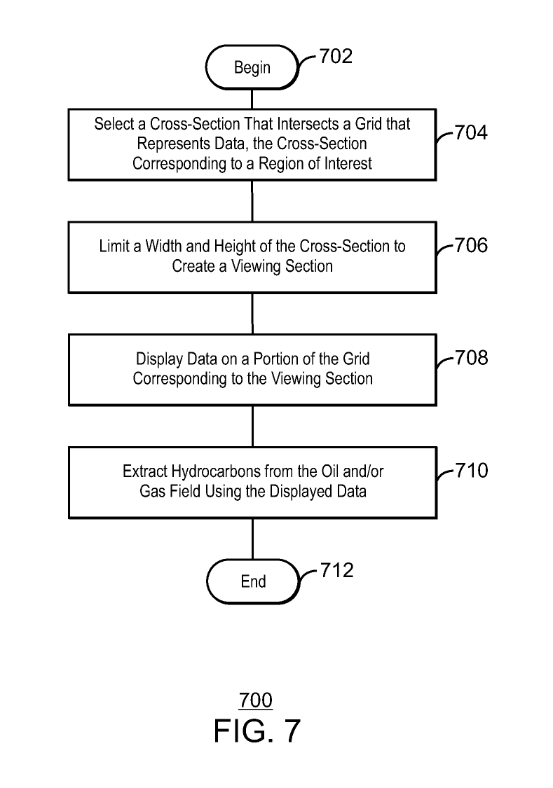

FIG. 7 is a process flow diagram showing a method for producing hydrocarbons from an oil and/or gas field according to exemplary embodiments of the present techniques. The process is generally referred to by the reference number 700. Those of ordinary skill in the art will appreciate that the present techniques may facilitate the production of hydrocarbons by producing visualizations that allow geologists, engineers and the like to determine a course of action to take to enhance hydrocarbon production from a subsurface region. By way of example, a visualization produced according to an exemplary embodiment of the present techniques may allow an engineer or geologist to determine a well placement to increase production of hydrocarbons from a subsurface region.

According to an exemplary embodiment of the present techniques, visualizations used to facilitate the production of hydrocarbons may be provided with respect to a grid that represents data. At block 704, a cross-section that intersects the grid is selected. The cross-section corresponds to a region of interest.

At block 706, a width and height of the cross-section are limited to create a viewing section. At block 708, data is displayed on a portion of the grid corresponding to the viewing section. Hydrocarbons are extracted from the oil and/or gas field using the displayed data, as shown at block 710. The method ends at block 712.

FIG. 8 is a block diagram of a computer network that may be used to perform a method for providing visualizations of data that represents a physical object according to exemplary embodiments of the present techniques. A central processing unit (CPU) 801 is coupled to system bus 802. The CPU 801 may be any general-purpose CPU, although other types of architectures of CPU 801 (or other components of exemplary system 800) may be used as long as CPU 801 (and other components of system 800) supports the inventive operations as described herein. The CPU 801 may execute the various logical instructions according to various exemplary embodiments. For example, the CPU 801 may execute machine-level instructions for performing processing according to the operational flow described above in conjunction with FIG. 6 or FIG. 7.

The computer system 800 may also include computer components such as a random access memory (RAM) 803, which may be SRAM, DRAM, SDRAM, or the like. The computer system 800 may also include read-only memory (ROM) 804, which may be PROM, EPROM, EEPROM, or the like. RAM 803 and ROM 804 hold user and system data and programs, as is known in the art. The computer system 800 may also include an input/output (I/O) adapter 805, a communications adapter 811, a user interface adapter 808, and a display adapter 809. The I/O adapter 805, the user interface adapter 808, and/or communications adapter 811 may, in certain embodiments, enable a user to interact with computer system 800 in order to input information.

The I/O adapter 805 preferably connects a storage device(s) 806, such as one or more of hard drive, compact disc (CD) drive, floppy disk drive, tape drive, etc. to computer system 800. The storage device(s) may be used when RAM 803 is insufficient for the memory requirements associated with storing data for operations of embodiments of the present techniques. The data storage of the computer system 800 may be used for storing information and/or other data used or generated as disclosed herein. The communications adapter 811 may couple the computer system 800 to a network 812, which may enable information to be input to and/or output from system 800 via the network 812 (for example, the Internet or other wide-area network, a local-area network, a public or private switched telephony network, a wireless network, any combination of the foregoing). User interface adapter 808 couples user input devices, such as a keyboard 813, a pointing device 807, and a microphone 814 and/or output devices, such as a speaker(s) 815 to the computer system 800. The display adapter 809 is driven by the CPU 801 to control the display on a display device 810 to, for example, display information or a representation pertaining to a portion of a subsurface region under analysis, such as displaying data corresponding to a generated viewing section, according to certain exemplary embodiments.

The architecture of system 800 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

The present techniques may be susceptible to various modifications and alternative forms, and the exemplary embodiments discussed above have been shown only by way of example. However, the present techniques are not intended to be limited to the particular embodiments disclosed herein. Indeed, the present techniques include all alternatives, modifications, and equivalents falling within the spirit and scope of the appended claims.

What is claimed is:

1. A method for providing a visualization of data describing a physical structure, the visualization being provided with respect to a grid that represents data, the method comprising:
selecting a cross-section that intersects the grid, the cross-section corresponding to a region of interest;
limiting at least one of a width and or a height of the cross-section to create a viewing section; and
displaying data on a portion of the grid corresponding to the viewing section.

2. The method recited in claim 1, comprising displaying the grid data on the cross-section prior to limiting at least one of the width or the height of the cross-section.

3. The method recited in claim 1, comprising selecting the viewing section such that the viewing section does not occlude an area of a scene for which occlusion is to be avoided.

4. The method recited in claim 1, comprising resizing at least one of the width or the height of the viewing section.

5. The method recited in claim 1, comprising displaying data on a portion of the grid corresponding to the new width and/or height of the viewing section.

6. The method recited in claim 1, comprising repositioning the viewing window to a new position with respect to the grid.

7. The method recited in claim 6, comprising displaying data on a portion of the grid corresponding to the new position of the viewing section.

8. The method recited in claim 1, comprising changing an orientation of the viewing section to a new orientation with respect to the grid.

9. The method recited in claim 8, comprising displaying data on a portion of the grid corresponding to the new orientation of the viewing section.

10. The method recited in claim 1, wherein the grid comprises a structured grid.

11. The method recited in claim 1, wherein the grid comprises an unstructured grid.

12. The method recited in claim 1, comprising:
selecting a second cross-section of the grid that corresponds to a second region of interest without respect to whether data corresponding to the second section of the grid, if displayed, would occlude a portion of the scene for which occlusion is to be avoided;
limiting at least one of a width or a height of the second cross-section to create a second viewing section such that the second viewing section, when applied to the grid, does not occlude the portion of the scene for which occlusion is to be avoided; and
displaying data on a portion of the grid corresponding to the second viewing section while the data displayed on the portion of the grid corresponding to the viewing section is still being displayed, wherein the display of the data on the portion of the grid corresponding to the second viewing section does not occlude the at least the portion of the scene for which occlusion is to be avoided.

13. A computer system that is adapted to provide a visualization of data describing a physical structure, the visualization being provided with respect to a grid that represents data, the computer system comprising:
a processor; and
a tangible, machine-readable storage medium that stores machine-readable instructions for execution by the processor, the machine-readable instructions comprising:
code that, when executed by the processor, is adapted to cause the processor to select a cross-section that intersects the grid, the cross-section corresponding to a region of interest;
code that, when executed by the processor, is adapted to cause the processor to limit at least one of a width and or a height of the cross-section to create a viewing section; and
code that, when executed by the processor, is adapted to cause the processor to display data on a portion of the grid corresponding to the viewing section.

14. The computer system recited in claim 13, comprising code that, when executed by the processor, is adapted to cause the processor to display the grid data on the plane prior to limiting at least one of the width or the height of the cross-section.

15. The computer system recited in claim 13, comprising code that, when executed by the processor, is adapted to cause the processor to select the viewing section such that the viewing section does not occlude an area of a display for which occlusion is to be avoided.

16. The computer system recited in claim 13, comprising code that, when executed by the processor, is adapted to cause the processor to resize at least one of the width or the height of the viewing section.

17. The computer system recited in claim 13, comprising code that, when executed by the processor, is adapted to cause the processor to reposition the viewing window to a new position with respect to the grid.

18. The computer system recited in claim 13, comprising code that, when executed by the processor, is adapted to cause the processor to change an orientation of the viewing section to a new orientation with respect to the grid.

19. The computer system recited in claim 13, wherein the grid comprises a structured grid.

20. The computer system recited in claim 13, wherein the grid comprises an unstructured grid.

21. A method for producing hydrocarbons from an oil and/or gas field, the method comprising:
selecting a cross-section that intersects a grid that represents data, the cross-section corresponding to a region of interest;
limiting at least one of a width or a height of the cross-section to create a viewing section;
displaying data on a portion of the grid corresponding to the viewing section; and
extracting hydrocarbons from the oil and/or gas field using the displayed data.
